(19) United States
(12) Patent Application Publication
(10) Pub. No.: US 2026/0116317 A1
(43) Pub. Date: Apr. 30, 2026

(54) VEHICLE INTERIOR PANEL

(71) Applicant: TOYODA GOSEI CO., LTD., Kiyosu-shi (JP)

(72) Inventor: Sadanori ANDO, Kiyosu-shi (JP)

(21) Appl. No.: 19/328,988

(22) Filed: Sep. 15, 2025

(30) Foreign Application Priority Data
Oct. 24, 2024 (JP) 2024-187255

(51) Int. Cl. B60R 13/02; B44F 5/00

(52) U.S. Cl. CPC B60R 13/0237; B44F 5/00

(57) ABSTRACT

A vehicle interior panel includes a base material and a decorative layer. The base material is made of a resin composition containing a scrap material obtained by pulverizing a resin molded article. The decorative layer is laminated on an outer surface of the base material. The base material includes particles dispersed in a base resin. The base resin is a principal component of the resin composition. The particles are derived from the scrap material and have a composition different from that of the base resin. The base material includes projecting portions, which are the particles projecting from an outer surface of the base resin. The decorative layer includes a base layer bonded to the outer surface of the base material, and multiple protrusions projecting from an outer surface of the base layer.

### CROSS-REFERENCE TO RELATED APPLICATIONS

This application is based upon and claims the benefit of priority from Japanese Patent Application No. 2024-187255, filed on Oct. 24, 2024, the entire contents of which are incorporated herein by reference.

### BACKGROUND

### 1. Field

The present disclosure relates to an interior panel for a vehicle.

### 2. Description of Related Art

A method has been introduced to produce resin molded articles by recovering scrap materials such as automobile bumper covers and reusing them as raw materials. Specifically, the scrap material is pulverized into granules. Then, the pulverized scrap material is mixed with a virgin material that is the same resin as that of a resin base material forming the scrap material. The recycled material thus obtained is supplied to an injection molding machine, melted by a heater, and injected into a mold cavity, thereby forming a resin molded article.

JP2002-144495A discloses a technique in which pulverized scrap material is mixed with cellulose fibers obtained from waste paper or wood flour obtained by crushing construction waste, thereby producing a recycled material having superior thermal and physical properties. Resin molded articles manufactured from such recycled materials exhibit improved heat resistance and strength.

However, recycled materials contain foreign matter such as paint film particles originating from the scrap material. Accordingly, when a resin molded article is formed from recycled material, the design surface of the molded article may include dispersed paint film particles. This may degrade the appearance of the resin molded article.

In order to address this, JP2002-144495A discloses a resin molded article in which a resin film is laminated onto the surface of a base material to conceal the surface pattern of the base material. This improves the appearance of the resin molded article.

Nevertheless, in such a resin molded article, foreign matter such as paint film particles may project from the surface of the base resin, which is the principal component of the base material. In this case, even when a resin film is laminated onto the surface of the base material, portions of the resin film overlying the projecting foreign matter projects relative to adjacent smooth regions. This may degrade the appearance of the resin molded article. Moreover, when such resin molded articles are applied to vehicle interior panels, projections on the otherwise smooth design surface may cause snag-like sensation, leading to an unsatisfactory tactile impression. Accordingly, there remains room for improvement in enhancing both the appearance and tactile impression of vehicle interior panels manufactured using recycled scrap material.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle interior panel includes a base material that is made of a resin composition containing a scrap material obtained by pulverizing a resin molded article, and a decorative layer laminated on an outer surface of the base material. The base material includes particles dispersed in a base resin. The base resin is a principal component of the resin composition. The particles are derived from the scrap material and have a composition different from that of the base resin. The base material includes projecting portions. The projecting portions are the particles projecting from an outer surface of the base resin. The decorative layer includes a base layer bonded to the outer surface of the base material, and multiple protrusions projecting from an outer surface of the base layer.

Other features and aspects will be apparent from the following detailed description, the drawings, and the claims.

### BRIEF DESCRIPTION OF THE DRAWINGS

FIG. 1 is a perspective view of a console box including an upper panel as a vehicle interior panel according to an embodiment.

FIG. 2 is a cross-sectional view of the upper panel shown in FIG. 1.

FIG. 3 is an enlarged cross-sectional view of a portion shown in FIG. 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

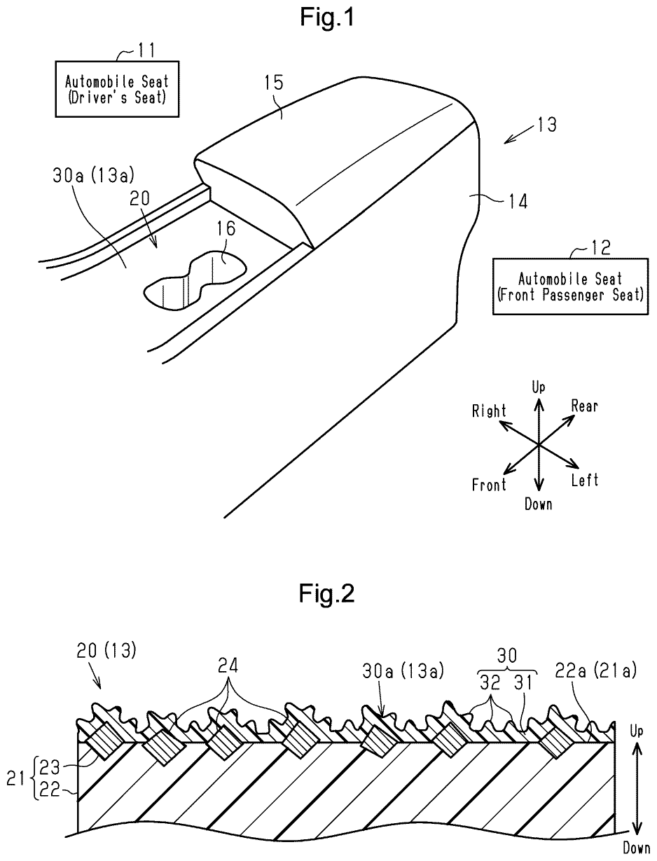

A vehicle interior panel according to an embodiment will now be described with reference to FIGS. 1 to 3. In the present embodiment, the vehicle interior panel is embodied as an upper panel 20 of a console box 13 disposed between a driver's seat 11 and a front passenger seat 12 in a passenger compartment of an automobile.

Hereinafter, the front-rear direction of the automobile will be referred to as a front-rear direction. The front side and the rear side in the front-rear direction will simply be referred to as forward and rearward. In addition, the width direction of the automobile will be referred to as a vehicle width direction, and a right side and a left side in the vehicle width direction when the automobile is viewed from the rear side will simply be referred to as a right side and a left side. Further, the up-down direction of the automobile when the automobile is on a horizontal plane will be referred to as an up-down direction, and the upper side and the lower side in the up-down direction will simply be referred to as an upper side and a lower side, respectively.

### Console Box 13

As shown in FIG. 1, two automobile seats arranged at a distance from each other in the vehicle width direction are disposed in a front portion of the passenger compartment. In the present embodiment, the right seat is the driver's seat 11, on which a driver sits, and the left seat is the front passenger seat 12, on which a passenger sits. The console box 13 extending in the front-rear direction is disposed between the driver's seat 11 and the front passenger seat 12.

The console box 13 includes a box body 14, an armrest 15, a cup holder 16, and an upper panel 20. The box body 14 has, for example, the shape of a box with a bottom and includes an upper opening that opens upward and a storage portion as a recessed portion continuous with the upper opening (neither is shown). The armrest 15 is attached to the box body 14 to close the upper opening of the box body 14. The console box 13 is configured such that, for example, the armrest 15 is moved relative to the box body 14 between a closed state, in which the armrest 15 closes the upper opening, and an open state, in which the armrest 15 opens the upper opening, thereby allowing articles to be put into and taken out of the storage portion through the upper opening.

The upper panel 20 is attached to a portion of the upper part of the box body 14 that is located forward of the armrest 15 and includes the cup holder 16. The upper panel 20 forms a design surface 13a of the console box 13.

### Upper Panel 20

As shown in FIG. 2, the upper panel 20 includes a base material 21 and a decorative layer 30.

The base material 21 is formed of a resin composition obtained by mixing virgin resin with scrap material obtained by pulverizing an automobile bumper cover. The bumper cover corresponds to a resin molded article, and includes, for example, a resin base material and a decorative layer laminated onto a front surface of the base material. The decorative layer includes, for example, a paint film, a plating layer, a hot stamping layer, a film layer, a vapor deposition layer, and a print layer. In the present embodiment, the decorative layer of the bumper cover is a paint film.

The base material 21 includes a base resin 22, which is the principal component of the resin composition, and paint film particles 23 as foreign matter dispersed in the base resin 22. The base resin 22 is, for example, polypropylene (PP). The thickness in the up-down direction of the base resin 22 is, for example, 2.5 mm. The paint film particles 23 are obtained by pulverizing the paint film of a bumper cover. The paint film contains a resin different from PP and a pigment as components. Accordingly, the paint film particles 23 differ in composition and coloration from the base resin 22, and correspond to particles. The maximum diameter of the paint film particles 23 is, for example, 50 μm.

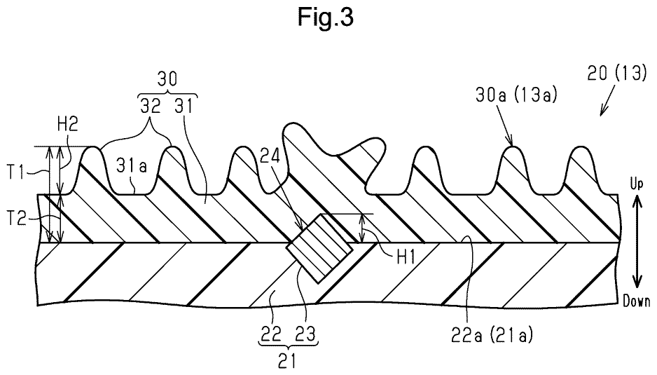

As shown in FIGS. 2 and 3, the base material 21 includes multiple projecting portions 24 on the outer surface (hereinafter referred to as an upper surface 21a). The projecting portions 24 are formed by the paint film particles 23 projecting from the outer surface (hereinafter referred to as an upper surface 22a) of the base resin 22. Projecting amounts H1 of the projecting portions 24 from the upper surface 22a are, for example, in a range of 10 μm to 30 μm (see FIG. 3).

The decorative layer 30 is, for example, a decorative film formed by embossing the surface of a resin film, and has an uneven design surface 30a. The design surface 30a forms a portion of the design surface 13a of the console box 13.

As shown in FIGS. 2 and 3, the decorative layer 30 includes a base layer 31, which is laminated and bonded to the upper surface 21a, and multiple protrusions 32 projecting from an outer surface (hereinafter, upper surface 31a) of the base layer 31. The base layer 31 covers the entire upper surface 21a from above. The thickness T2 in the up-down direction of the base layer 31 is set such that the thickness T1 in the up-down direction of the decorative layer 30 is, for example, in a range of 0.1 mm to 0.5 mm. The protrusions 32 form the uneven contour of the design surface 30a and are provided across the entire upper surface 31a of the base layer 31. The projecting amounts H2 of the protrusions 32 from the upper surface 31a are preferably, for example, in a range of 10 μm to 80 μm. In the present embodiment, the projecting amounts H2 of the protrusions 32 are set such that the average value A1 of the projecting amounts H2 of the protrusions 32 is greater than or equal to the average value A2 of the projecting amounts H1 of the projecting portions 24 (A1≥A2).

### Operation of the Present Embodiment

The decorative layer 30, which includes multiple protrusions 32, is laminated onto the upper surface 21a of the base material 21. Accordingly, even though the projecting portions 24 are present on the upper surface 21a of the base material 21, the projecting portions 24 are concealed by the decorative layer 30. As a result, portions of the decorative layer 30 overlying the projecting portions 24 blend in with the protrusions 32 of the decorative layer 30 and thus become less conspicuous.

In addition, when an occupant touches the design surface 30a of the upper panel 20, the occupant's fingers first come into contact with the protrusions 32. Accordingly, the snag-like tactile sensation that would otherwise occur at portions of the decorative layer 30 overlying the projecting portions 24 is reduced.

### Advantages of the Present Embodiment

(1) The upper panel 20 includes the base material 21 and the decorative layer 30. The base material 21 is made of a resin composition containing a scrap material obtained by pulverizing a bumper cover, and the decorative layer 30 is laminated on the upper surface 21a of the base material 21. The base material 21 contains the paint film particles 23 dispersed within the base resin 22, the paint film particles 23 being derived from the scrap material and differing in composition from the base resin 22. The projecting portions 24 are formed on the upper surface 22a of the base resin 22 by the paint film particles 23 projecting above the upper surface 21a of the base material 21. The decorative layer 30 includes the base layer 31, bonded to the upper surface 21a of the base material 21, and the protrusions 32, projecting from the upper surface 31a of the base layer 31.

This configuration operates in the above-described manner. It is thus possible to suppress deterioration of the appearance and the tactile impression of the upper panel 20, which uses scrap material.

(2) The average value A1 of the projecting amounts H2 of the protrusions 32 is greater than or equal to the average value A2 of the projecting amounts H1 of the projecting portions 24.

According to this configuration, by setting the projecting amounts H2 of the protrusions 32 to be sufficiently large, deterioration in the appearance of the upper panel 20 is suppressed in a favorable manner. Further, the configuration reliably suppresses deterioration of the tactile impression of the upper panel 20 that would otherwise be caused by snag-like tactile sensation. It is thus possible to further suppress deterioration of the appearance and the tactile impression of the upper panel 20, which uses scrap material.

### Modifications

The above-described embodiment may be modified as follows. The above-described embodiment and the following modifications can be combined as long as the combined modifications remain technically consistent with each other.

The resin composition according to the present disclosure is not limited to the mixed material obtained by mixing a scrap material and a virgin material of PP as illustrated in the above-described embodiment, and may be composed of only a scrap material.

The particles according to the present disclosure are not limited to the paint film particles 23 illustrated in the above-described embodiment. For example, when a front grille formed of a resin base material with a plating layer laminated on its front surface is employed as the scrap material, metallic fragments obtained by pulverizing the plating layer corresponds to the particles of the present disclosure. In addition, for example, when the base material constituting the resin molded article is made of a fiber-reinforced resin, glass fibers contained in the fiber-reinforced resin correspond to the particles according to the present disclosure.

The base resin 22 is not limited to PP illustrated in the above-described embodiment. For example, when a scrap material obtained by pulverizing a resin molded article having a base material made of an acrylonitrile-butadiene-styrene copolymer (ABS) resin is used, the base resin 22 is an ABS resin.

The projecting amounts H2 of the protrusions 32 do not necessarily need to be set such that the average value A1 is greater than or equal to the average value A2 as illustrated in the above-described embodiments. The average value A1 may be set to be less than the average value A2 as long as the advantages of the above-described embodiment are achieved.

The scrap material according to the present disclosure is not limited to a resin molded article for automobiles, such as the bumper cover illustrated in the above-described embodiments or the front grille in the foregoing modification. For example, the scrap material may be derived from resin molded articles used in household electrical appliances. In such cases, it suffices that the resin molded article include a resin base material and a decorative layer laminated on the front surface of the base material.

The vehicle interior panel according to the present disclosure is not limited to the upper panel 20 of the console box 13 as illustrated in the above-described embodiments. The present disclosure may also be applied to other interior panels such as a door trim or an instrument panel.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle interior panel, comprising:
a base material that is made of a resin composition containing a scrap material obtained by pulverizing a resin molded article; and
a decorative layer laminated on an outer surface of the base material, wherein
the base material includes particles dispersed in a base resin, the base resin being a principal component of the resin composition,
the particles are derived from the scrap material and have a composition different from that of the base resin,
the base material includes projecting portions, the projecting portions being the particles projecting from an outer surface of the base resin, and
the decorative layer includes:
a base layer bonded to the outer surface of the base material; and
multiple protrusions projecting from an outer surface of the base layer.

2. The vehicle interior panel according to claim 1, wherein an average value of projecting amounts of the protrusions is greater than or equal to an average value of projecting amounts of the projecting portions.
